(19) United States
(12) Patent Application Publication
(10) Pub. No.: US 2019/0311288 A1
(43) Pub. Date: Oct. 10, 2019

(54) METHOD FOR MACHINE LEARNING, NON-TRANSITORY COMPUTER-READABLE STORAGE MEDIUM FOR STORING PROGRAM, APPARATUS FOR MACHINE LEARNING

(71) Applicant: FUJITSU LIMITED, Kawasaki-shi (JP)

(72) Inventor: Yui Noma, Kawasaki (JP)

(73) Assignee: FUJITSU LIMITED, Kawasaki-shi (JP)

(21) Appl. No.: 16/358,750

(22) Filed: Mar. 20, 2019

(30) Foreign Application Priority Data
Apr. 5, 2018 (JP) 2018-072981

(51) Int. Cl. G06N 20/00; G06N 5/04

(52) U.S. Cl. CPC G06N 20/00; G06N 20/20; G06N 5/048

(57) ABSTRACT

A method for machine learning performed by a computer includes: (i) executing a first process that includes executing machine learning on weight values corresponding to multiple functions to be used to calculate similarities between items forming pairs and included in first and second data included in a teacher data item for each of the pairs of items based on the teacher data item stored in a memory; and (ii) executing a second process that includes identifying evaluation functions to be used to calculate the similarities between the items forming the pairs based on the multiple functions and the weight values corresponding to the multiple functions.

### CROSS-REFERENCE TO RELATED APPLICATION

This application is based upon and claims the benefit of priority of the prior Japanese Patent Application No. 2018-72981, filed on Apr. 5, 2018, the entire contents of which are incorporated herein by reference.

### FIELD

The embodiment discussed herein is related to a method and an apparatus for machine learning, and a non-transitory computer-readable storage medium for storing a program.

### BACKGROUND

For example, a provider (hereinafter also merely referred to as provider in some cases) that provides a service to a user builds and operates a business system (hereinafter also referred to as information processing system in some cases) for providing the service. For example, the provider builds a business system for executing a process (hereinafter also referred to as name identification process) of identifying a combination (hereinafter also referred to as pair of records) of records indicating the same details and stored in different databases and associating the records with each other.

In the name identification process, details of the records stored in the databases are compared with each other for each combination (hereinafter also referred to as pair of items) of items having the same meaning. In the name identification process, for example, a binary classifier (for example, a support vector machine, logistic regression, or the like) subjected to machine learning is used to identify a pair of records including a pair of items whose similarity relationship has been determined to satisfy a predetermined requirement as a pair of records indicating the same details.

Examples of the related art include Japanese Laid-open Patent Publication No. 2012-159886, Japanese Laid-open Patent Publication No. 2012-159884, and Japanese Laid-open Patent Publication No. 2016-118931.

Another example of the related art includes “Peter Christen “Data Matching Concepts and Techniques for Record Linkage, Entity Resolution, and Duplicate Detection” 2012 Springer”.

### SUMMARY

According to an aspect of the embodiments, a method for machine learning performed by a computer includes: (i) executing a first process that includes executing machine learning on weight values corresponding to multiple functions to be used to calculate similarities between items forming pairs and included in first and second data included in a teacher data item for each of the pairs of items based on the teacher data item stored in a memory; and (ii) executing a second process that includes identifying evaluation functions to be used to calculate the similarities between the items forming the pairs based on the multiple functions and the weight values corresponding to the multiple functions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration of an information processing system;

FIG. 2 describes an overview of a name identification process to be executed by an information processing device;

FIG. 3 describes the overview of the name identification process to be executed by the information processing device;

FIG. 4 describes the overview of the name identification process to be executed by the information processing device;

FIG. 5 illustrates a hardware configuration of the information processing device;

FIG. 6 illustrates functions of the information processing device;

FIG. 7 describes an overview of a learning process according to an embodiment;

FIG. 8 describes details of the learning process according to the embodiment;

FIG. 9 describes details of the learning process according to the embodiment;

FIG. 10 describes details of the learning process according to the embodiment;

FIG. 11 describes details of the learning process according to the embodiment;

FIG. 12 describes details of the learning process according to the embodiment;

FIG. 13 describes details of the learning process according to the embodiment;

FIG. 14 describes details of the learning process according to the embodiment;

FIG. 15 describes details of the learning process according to the embodiment;

FIG. 16 describes a specific example of first master data;

FIG. 17 describes a specific example of second master data;

FIG. 18 describes a specific example of a teacher data item;

FIG. 19 describes a specific example of importance level information;

FIG. 20 describes a specific example of the teacher data item;

FIGS. 21A and 21B describe details of the learning process according to the embodiment;

FIGS. 22A and 22B describe details of the learning process according to the embodiment;

FIG. 23 describes details of the learning process according to the embodiment;

FIG. 24 describes details of the learning process according to the embodiment;

FIGS. 25A and 25B describe details of the learning process according to the embodiment;

FIGS. 26A and 26B describe details of the learning process according to the embodiment;

FIG. 27 describes details of the learning process according to the embodiment; and

FIG. 28 describes details of the learning process according to the embodiment.

### DESCRIPTION OF EMBODIMENTS

In the aforementioned name identification process, the provider determines, for each of pairs of items, a function to be used to compare records forming a pair with each other, for example. For example, in this case, the provider selects a function for each of pairs of items based on characteristics of information set in the pairs of items. Thus, the provider may accurately determine whether or not details of a record forming a pair with another record are the same as those of the other record.

However, when the number of pairs of items to be compared is large, a workload, caused by the determination of functions, of the provider increases. Thus, the provider may not easily determine functions to be used to compare records forming pairs with each other.

According to an aspect, the present disclosure aims to provide a learning program and a learning method that enable a function to be used to compare multiple records with each other to be easily determined.

<Configuration of Information Processing System>

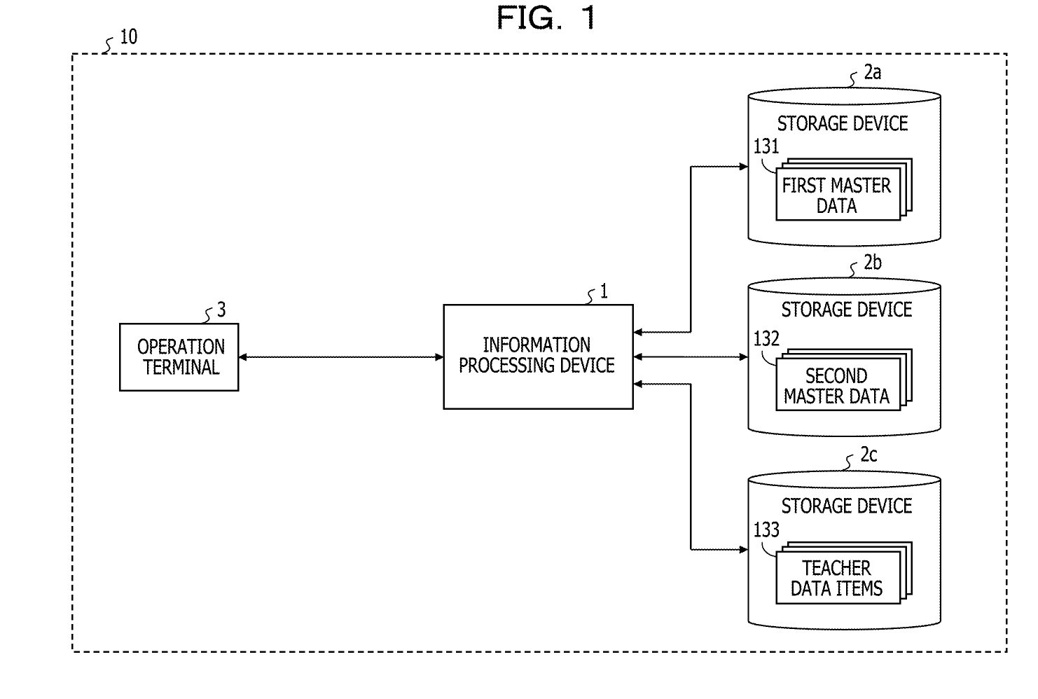

FIG. 1 illustrates a configuration of an information processing system 10. The information processing system 10 illustrated in FIG. 1 includes an information processing device 1, storage devices 2a, 2b, and 2c, and an operation terminal 3 to be used by a provider to input information or the like. The storage devices 2a, 2b, and 2c are hereinafter collectively referred to as storage devices 2 in some cases. The storage devices 2a, 2b, and 2c may be a single storage device.

In the storage device 2a, first master data 131 is stored. In the storage device 2b, second master data 132 is stored. Each of the first data 131 and the second data 132 is composed of multiple records to be subjected to a name identification process.

In the storage device 2c, teacher data items 133, which are to be subjected to machine learning in order to execute the name identification process in advance, are stored. Each of the teacher data items 133 includes, for example, a record (hereinafter also referred to as first data) including the same items as the first master data 131, a record (hereinafter also referred to as second data) including the same items as the second master data 132, and information (hereinafter referred to as similarity information) indicating whether or not the records forming a pair are similar to each other.

The information processing device 1 executes machine learning on a binary classifier using, as input data, the teacher data items 133 stored in the storage device 2c. Then, the information processing device 1 uses the binary classifier subjected to the machine learning to determine whether or not records (hereinafter also referred to as third data) included in the first master data 131 stored in the storage device 2a are similar to records (hereinafter also referred to as fourth data) included in the second master data 132 stored in the storage device 2b. The information processing device 1 executes a process (name identification process) of associating records determined to be similar to each other with each other. An overview of the name identification process to be executed by the information processing device 1 is described below.

<Overview of Name Identification Process>

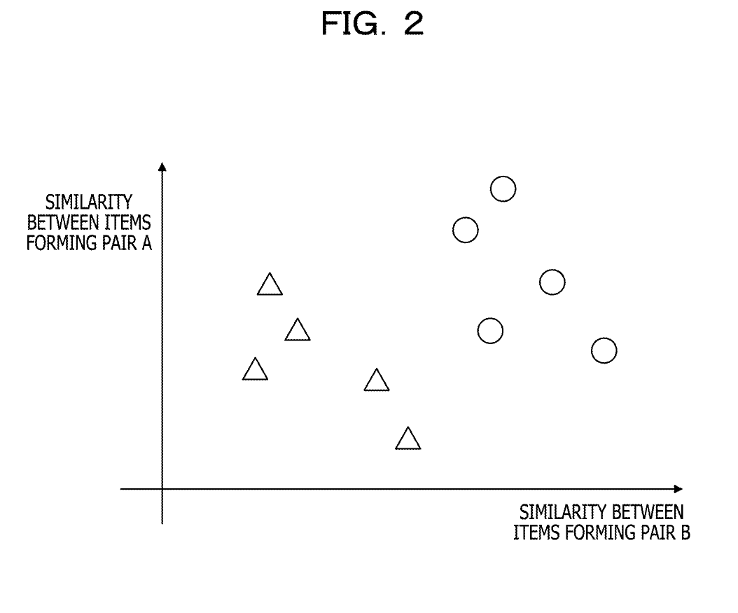

FIGS. 2 to 4 describe the overview of the name identification process to be executed by the information processing device 1. FIGS. 2 to 4 describes the name identification process in the case where the machine learning is executed with active learning on the teacher data items 133. The active learning is a method for executing machine learning while sequentially generating new teacher data items 133 including information entered by the provider, thereby suppressing the number of teacher data items 133 to be subjected to the machine learning. An example illustrated in FIGS. 2 to 4 describes the case where each of pairs of records included in each of the teacher data items 133 includes only a pair A of items and a pair B of items.

For example, the information processing device 1 calculates, for each of pairs of records included in each of the teacher data items 133 stored in the storage device 2c, a similarity between items forming a pair A and included in the pair of records and a similarity between items forming a pair B and included in the pair of records. For example, the information processing device 1 uses functions defined for pairs of items by the provider to calculate a similarity between items forming a pair A and included in each of pairs of records and a similarity between items forming a pair B and included in each of the pairs of records.

For example, as illustrated in FIG. 2, the information processing device 1 plots points corresponding to the teacher data items 133 in a high-dimensional space (two-dimensional space in the example illustrated in FIG. 2) in which dimensions correspond to similarities between the items forming the pairs. In the example illustrated in FIG. 2, each of “circles” indicates a point corresponding to a teacher data item 133 including similarity information indicating that records forming a pair are similar to each other, and each of “triangles” indicates a point corresponding to a teacher data item 133 including similarity information indicating that records forming a pair are not similar to each other.

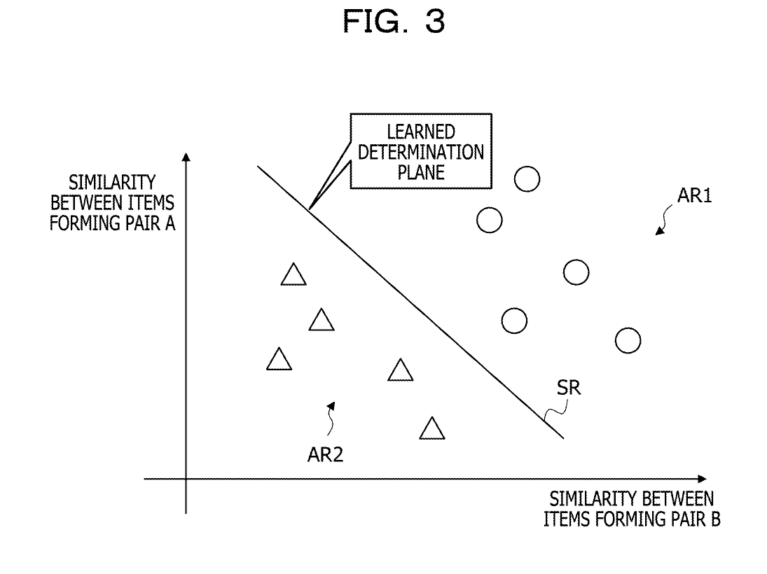

After that, the information processing device 1 executes the machine learning on the binary classifier using, as input data, information of the points (corresponding to the teacher data items 133) plotted in the high-dimensional space. For example, as illustrated in FIG. 3, the information processing device 1 acquires a boundary (hereinafter also referred to as determination plane (SR)) between the points indicated by the “circles” and the points indicated by the “triangles”. As illustrated in FIG. 3, a region that is among regions obtained by dividing the high-dimensional space based on the determination plane SR and is farther away from the origin of the high-dimensional space is also referred to as region AR1, and a region that is among the regions obtained by dividing the high-dimensional space based on the determination plane SR and is closer to the origin of the high-dimensional space is also referred to as region AR2.

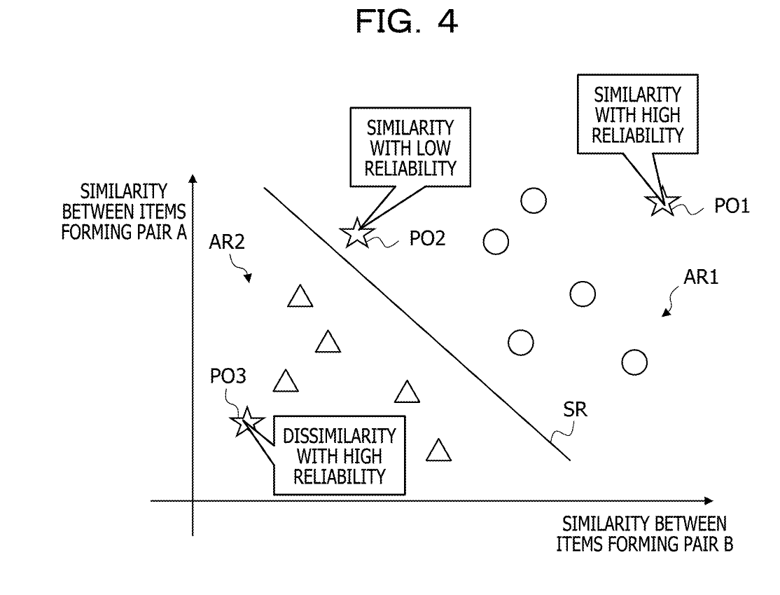

Then, the information processing device 1 uses the determination plane SR to determine, for each of pairs of records included in the first master data 131 and records included in the second master data 132, whether or not records that forming the pair are similar to each other, as illustrated in FIG. 4. Then, the information processing device 1 calculates reliabilities of the results of the determination. For example, as illustrated in FIG. 4, the information processing device 1 determines that records forming a pair corresponding to a point PO1 included in the region AR1 and plotted at a position far away from the determination plane SR have details similar to each other with a high reliability (for example, a reliability close to 1). In addition, for example, the information processing device 1 determines that records forming a pair corresponding to a point PO2 included in the region AR1 and plotted at a position close to the determination plane SR have details similar to each other with a low reliability (for example, a reliability close to 0). Furthermore, for example, the information processing device 1 determines that records forming a pair corresponding to a point PO3 included in the region AR2 and plotted at a position far away from the determination plane SR have details dissimilar from each other with a high reliability (for example, a reliability close to 1).

The information processing device 1 may calculate the reliabilities using the following Equation 1. X in Equation 1 is a variable indicating a distance from the determination plane SR to each point.

A reliability=0.5*tanh(X)+0.5 (1)

The information processing device 1 identifies a pair of records (for example, a pair of records having a reliability closest to 0.5) having a reliability closest to a predetermined value among the pairs of records included in the first master data 131 and records included in the second master data 132. Then, when the provider inputs information indicating whether or not the records forming the identified pair are similar to each other, the information processing device 1 generates a new teacher data item 133 including the identified pair of records and the information (input by the provider) indicating whether or not the records forming the identified pair are similar to each other, and executes the machine learning on the generated teacher data item 133.

For example, the information processing device 1 executes the machine learning on the binary classifier while sequentially generating new teacher data items 133 including information indicating results of determination by the provider. Thus, the information processing device 1 may efficiently generate new teacher data items 133 that enable the accuracy of the binary classifier to be improved. Accordingly, the information processing device 1 may suppress the number of teacher data items 133 to be subjected to the machine learning in order to improve the accuracy of the binary classifier to a desirable level.

After that, the information processing device 1 uses the determination plane SR after the completion of the machine learning executed on a predetermined number of teacher data items 133 to determine whether or not the records included in the first master data 131 and forming the pairs with the records included in the second master data 132 are similar to the records included in the second master data 132 and forming the pairs with the records included in the first master data 131. Then, the information processing device 1 associates records forming a pair and determined to be similar to each other with each other (in the name identification process).

When the aforementioned name identification process is to be executed, the provider determines, for each of the pairs of items, a function to be used to compare records forming a pair with each other, for example. For example, the provider selects functions corresponding to characteristics or the like of the pairs of items. Thus, the provider may compare records forming a pair with each other with high accuracy.

However, when the number of pairs of items to be compared with each other is large, a workload, caused by the determination of functions, of the provider may increase. Thus, the provider may not easily determine a function to be used to compare records forming a pair with each other.

The information processing device 1 according to the embodiment executes the machine learning on weight values corresponding to multiple functions to be used to calculate similarities between items forming pairs and included in pairs of records of teacher data items 133, based on the teacher data items 133 stored in the storage devices 2. Then, the information processing device 1 identifies, for each of the pairs of items, an evaluation function to be used to calculate a similarity between the items forming the pair, based on the multiple functions and the weight values corresponding to the multiple functions.

For example, the information processing device 1 according to the embodiment executes the machine learning on a function (for example, logistic regression) using, as an objective variable, similarity information included in the teacher data items 133 and using, as an explanatory variable, similarities between the items forming the pairs and included in the pairs of records, thereby acquiring the weight values for the pairs of items and for the multiple functions. Then, the information processing device 1 calculates, as evaluation functions for the pairs of items, functions using the acquired weight values for the pairs of items.

Thus, the information processing device 1 may acquire the weight values of the functions to be used to calculate similarities between the items forming the pairs. Accordingly, the information processing device 1 may calculate the similarities using the same functions (multiple functions) for all the pairs of items by replacing the weight values of the functions with each other for each of the pairs of items. Thus, the provider may not determine a function for each pair of items and may reduce a workload caused by the execution of the name identification process.

<Hardware Configuration of Information Processing System>

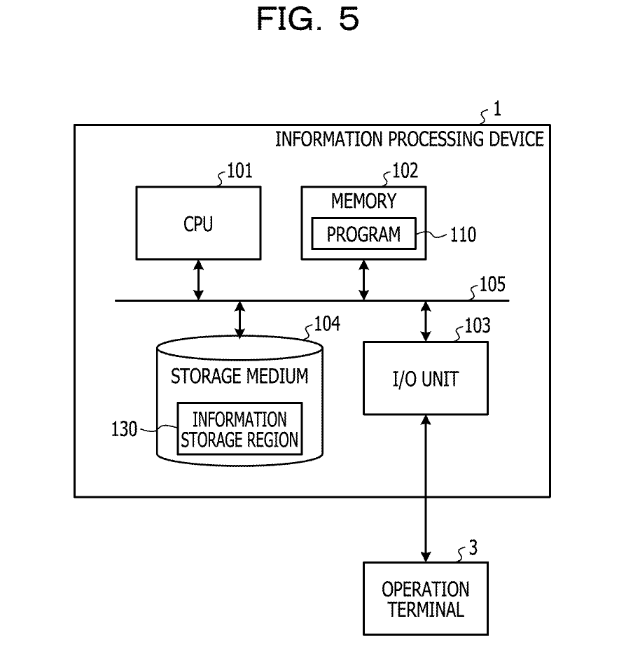

Next, a hardware configuration of the information processing system 10 is described. FIG. 5 illustrates a hardware configuration of the information processing device 1.

The information processing device 1 includes a CPU 101 serving as a processor, a memory 102, an external interface (input and output (I/O) unit) 103, and a storage medium 104. The units 101 to 104 are connected to each other via a bus 105.

The storage medium 104 stores a program 110 for executing a process (hereinafter also referred to as learning process) of executing the machine learning on teacher data items 133, for example.

The storage medium 104 includes an information storage region 130 (hereinafter also referred to as storage section 130) for storing information to be used in the learning process. The storage devices 2 described with reference to FIG. 1 may correspond to the information storage region 130.

The CPU 101 executes the program 110 loaded in the memory 102 from the storage medium 104 and executes the learning process.

The external interface 103 communicates with the operation terminal 3, for example.

<Functions of Information Processing System>

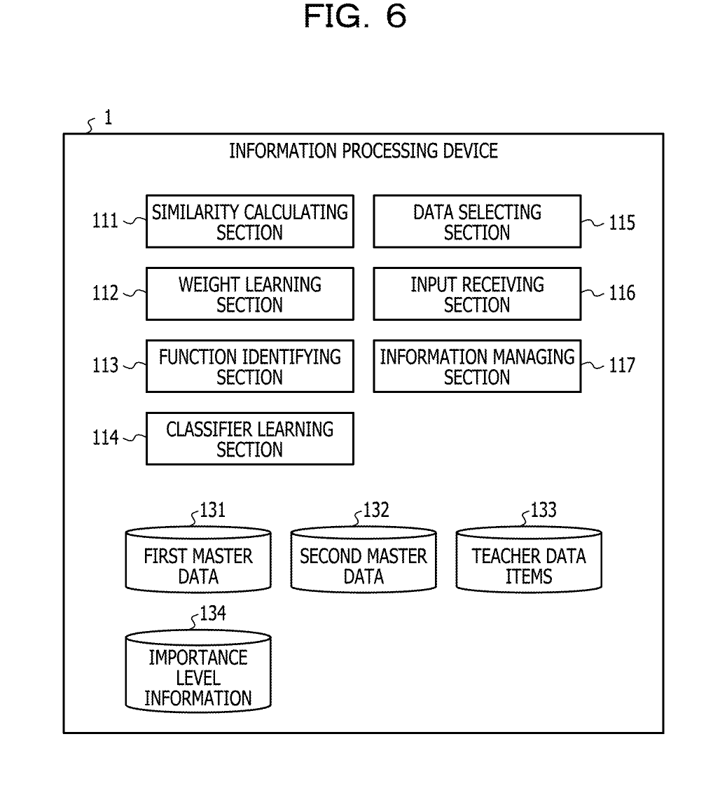

Next, functions of the information processing system 10 are described. FIG. 6 illustrates functions of the information processing device 1.

The information processing device 1 causes hardware including the CPU 101 and the memory 102 and the program 110 to closely collaborate with each other, thereby enabling various functions including a similarity calculating section 111, a weight learning section 112, a function identifying section 113, a classifier learning section 114, a data selecting section 115, an input receiving section 116, and an information managing section 117.

The information processing device 1 stores the first master data 131, the second master data 132, teacher data items 133, and importance level information 134 in the information storage region 130, as illustrated in FIG. 6.

The similarity calculating section 111 uses multiple functions to calculate similarities between items forming pairs and included in pairs of records of the teacher data items 133 stored in the information storage region 130 for each of the pairs of records of the teacher data items 133.

The weight learning section 112 executes, based on the teacher data items 133 stored in the information storage region 130, the machine learning on the weight values corresponding to the multiple functions to be used to calculate the similarities between the items forming the pairs and included in the pairs of records of the teacher data items 133. For example, the weight learning section 112 executes the machine learning on the weight values for the pairs of items and for the multiple functions by using the function (for example, logistic regression) using, as the objective variable, similarity information included in the teacher data items 133 and using, as the explanatory variable, the similarities (calculated by the similarity calculating section 111) for each of the pairs of items and for each of the multiple functions.

The function identifying section 113 identifies, for each of the pairs of items, an evaluation function to be used to calculate a similarity between the items forming the pair, based on the multiple functions and the weight values corresponding to the multiple functions.

The classifier learning section 114 executes the machine learning on the binary classifier based on the teacher data items 133 stored in the information storage region 130.

The data selecting section 115 uses the binary classifier subjected to the machine learning by the classifier learning section 114 to determine, for each of the pairs of records included in the first and second master data 131 and 132 stored in the information storage region 130, whether or not records forming the pair are similar to each other and calculates reliabilities of the results of the determination. Then, the data selecting section 115 identifies (selects) a pair of records having a calculated reliability closest to the predetermined value.

The input receiving section 116 receives information input to the information processing device 1 by the provider and indicating whether or not records forming the pair selected by the data selecting section 115 are similar to each other.

The information managing section 117 acquires the first master data 131, the second master data 132, the teacher data items 133, and the like stored in the information storage region 130. The information managing section 117 generates a new teacher data item 133 including the pair, selected by the data selecting section 115, of records and the input information received by the input receiving section 116. The importance level information 134 is described later.

<Overview of Embodiment>

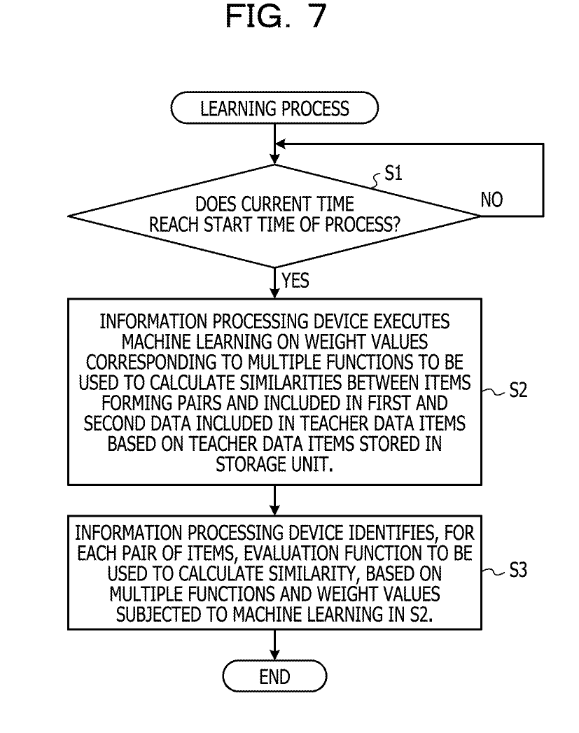

Next, an overview of the embodiment is described. FIG. 7 describes an overview of the learning process according to the embodiment.

The information processing device 1 stands by until the current time reaches start time of the learning process (No in S1). The learning process may be started when the provider inputs information indicating the start of the learning process to the information processing device 1.

When the current time reaches the start time of the learning process (Yes in S1), the information processing device 1 executes, based on the teacher data items 133 stored in the information storage region 130, the machine learning on the weight values corresponding to the multiple functions to be used to calculate the similarities between the items forming the pairs and included in the pairs of records of the teacher data items 133 (in S2).

After that, the information processing device 1 identifies, for each of the pairs of items, evaluation functions to be used to calculate the similarities between the items forming the pairs based on the multiple functions and the weight values subjected to the machine learning in the process of S2 (in S3).

For example, the information processing device 1 according to the embodiment executes the machine learning on the function (for example, logistic regression) using, as the objective variable, similarity information included in the teacher data items 133 and using, as the explanatory variable, the similarities between the items forming the pairs and included in the pairs of records, thereby acquiring the weight values for the pairs of items and for the multiple functions. Then, the information processing device 1 calculates, as evaluation functions for the pairs of items, functions using the acquired weight values for the pairs of items.

Thus, the information processing device 1 may acquire the weight values of the functions to be used to calculate the similarities between the items forming the pairs. Accordingly, the information processing device 1 may calculate the similarities using the same functions (multiple functions) for all the pairs of items by replacing the weight values of the functions with each other for each of the pairs of items. Thus, the provider may not determine a function for each of the pairs of items and may reduce a workload caused by the execution of the name identification process.

<Details of Embodiment>

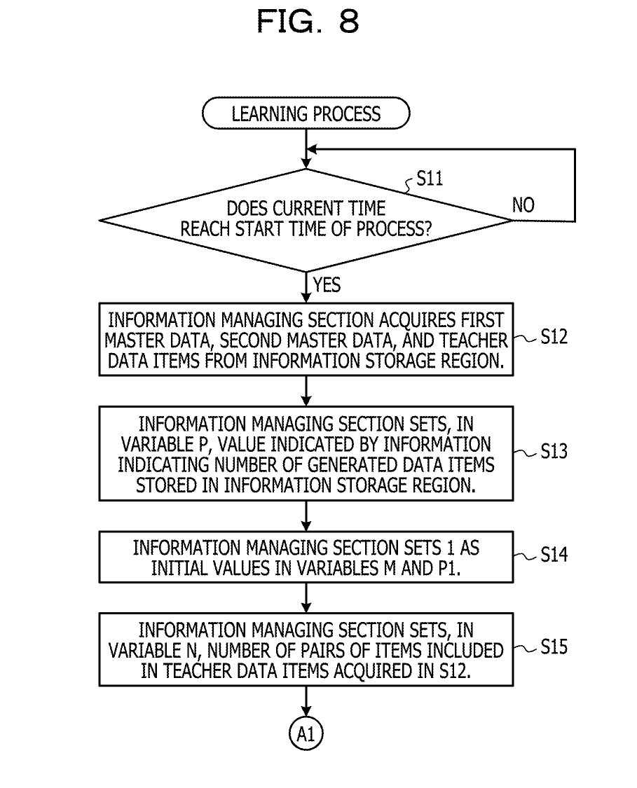

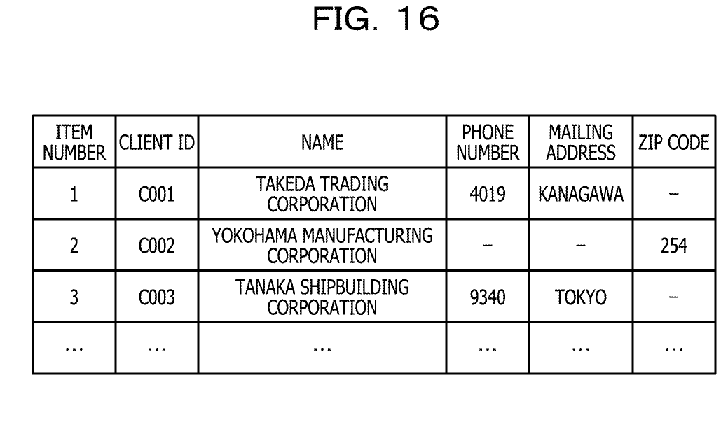

Next, details of the embodiment are described. FIGS. 8 to 15 describe details of the learning process according to the embodiment. FIGS. 16 to 28 describe details of the learning process according to the embodiment. The details of the learning process illustrated in FIGS. 8 to 15 are described with reference to FIGS. 16 to 28.

As illustrated in FIG. 8, the information processing device 1 stands by until the current time reaches the start time of the learning process (No in S11). When the current time reaches the start time of the learning process (Yes in S11), the information managing section 117 of the information processing device 1 acquires the first master data 131, the second master data 132, and the teacher data items 133 from the information storage region 130 (in S12). Specific examples of the first master data 131, the second master data 132, and the teacher data items 133 are described below.

<Specific Example of First Master Data>

First, a specific example of the first master data 131 is described. FIG. 16 describes the specific example of the first master data 131.

The first master data 131 illustrated in FIG. 131 includes an “item number” item identifying the records included in the first master data 131, a “client ID” item in which identification information of clients is set, a “name” item in which the names of the clients are set, a “phone number” item in which phone numbers of the clients are set, an “mailing address” item in which mailing addresses of the clients are set, and a “postal code” item in which postal codes of the clients are set.

In the first master data 131 illustrated in FIG. 16, in information indicating “1” in the “item number” item, “C001” is set as a “client ID”, “Takeda Trading Corporation” is set as a “name”, “4019” is set as a “phone number”, and “Kanagawa” is set as a “mailing address”. In the first master data 131 illustrated in FIG. 16, in the information indicating “1” in the “item number” item, “-” indicating that information is not set is set as a “zip code”. A description of other information illustrated in FIG. 16 is omitted.

<Specific Example of Second Master Data>

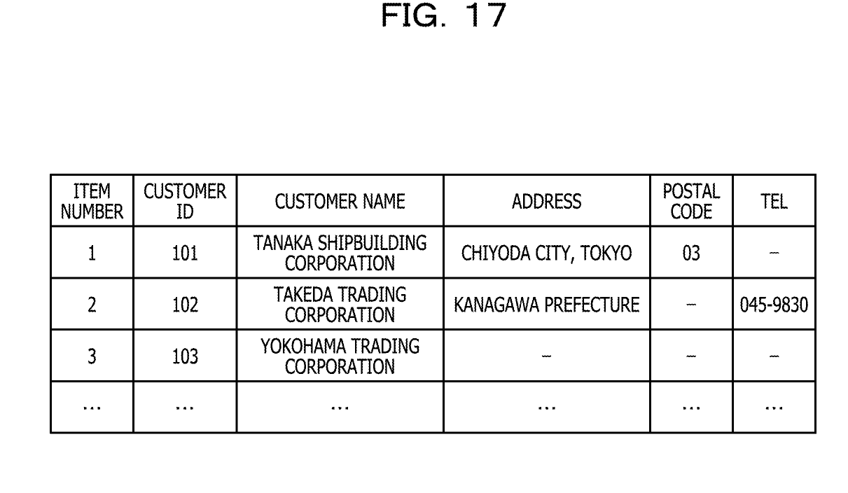

Next, a specific example of the second master data 132 is described. FIG. 17 describes the specific example of the second master data 132.

The second master data 132 illustrated in FIG. 17 includes an “item number” item identifying the records included in the second master data 132, a “customer ID” item in which identification information of customers is set, a “customer name” item in which the names of the customers are set, an “address” item in which addresses of the customers are set, a “postal code” item in which postal codes of the customers are set, and a “Tel” item in which phone numbers of the customers are set.

In the second master data 132 illustrated in FIG. 17, in information indicating “1” in the “item number” item, “101” is set as a “customer ID”, “Tanaka Shipbuilding Corporation” is set as a “customer name”, “Chiyoda City, Tokyo” is set as an “address”, and “03” is set as a “postal code”. In the second master data 132 illustrated in FIG. 17, in the information indicating “1” in the “item number” item, “-” is set as “Tel”. A description of other information illustrated in FIG. 17 is omitted.

In the “client ID”, “name”, “phone number”, “address”, and “zip code” items included in the first master data 131 illustrated in FIG. 16, information of the same details as those indicated in the “customer ID”, “customer name”, “Tel”, “address”, and “postal code” items included in the second master data 132 illustrated in FIG. 17 may be set. In this case, the information processing device 1 identifies a combination of the “client ID” and “customer ID” items of the first and second master data 131 and 132, a combination of the “name” and “customer name” items of the first and second master data 131 and 132, a combination of the “phone number” and “Tel” items of the first and second master data 131 and 132, a combination of the “mailing address” and “address” items of the first and second master data 131 and 132, and a combination of the “zip code” and “postal code” items of the first and second master data 131 and 132 as pairs of items to be used in the name identification process.

<Specific Example of Teacher Data Items>

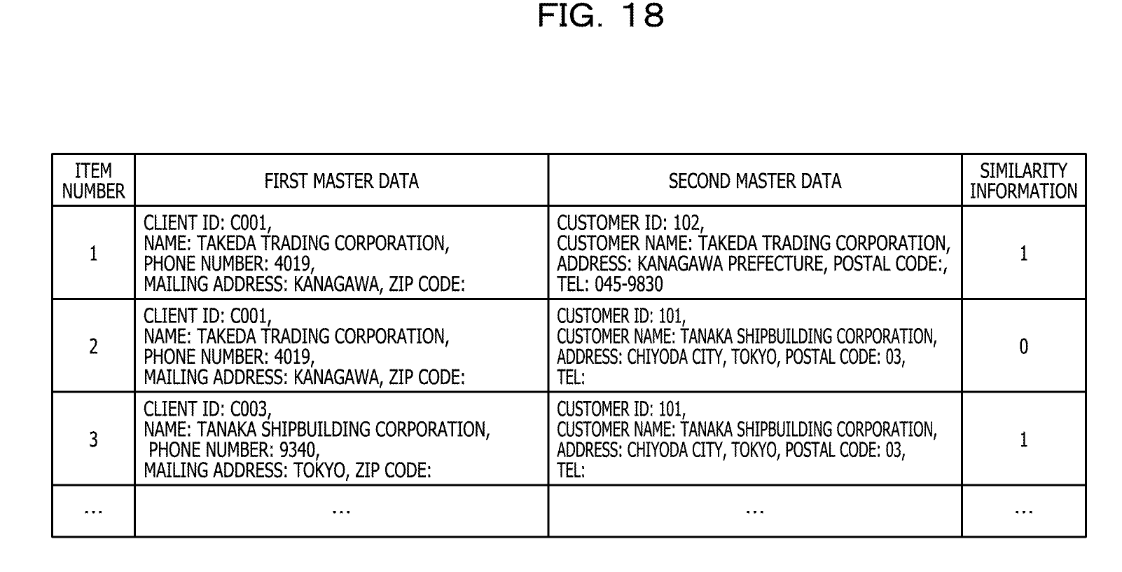

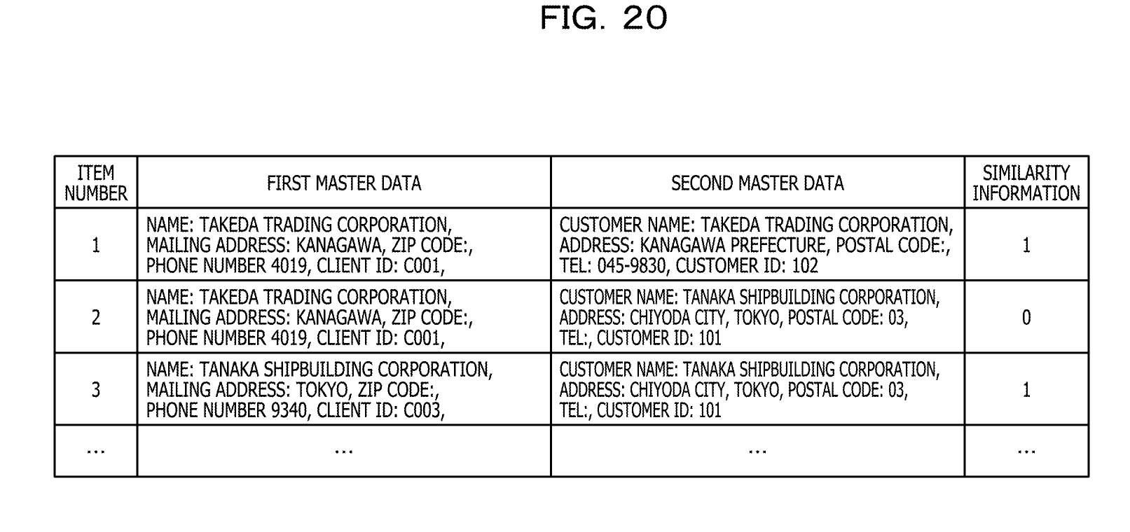

Next, a special example of a teacher data item 133 is described. FIGS. 18 and 20 describe the special example of the teacher data item 133.

Each of teacher data items 133 illustrated in FIGS. 18 and 20 includes an “item number” item identifying records included in the teacher data item 133 and a “first master data” item in which records having the same items as the records included in the first master data 131 are set. Each of the teacher data items 133 illustrated in FIGS. 18 and 20 also includes a “second master data” item in which records having the same items as the records included in the second master data 132 are set and a “similarity information” item in which information of similarities between the records forming pairs and set in the “first master data” item and the records forming the pairs and set in the “second master data” item is set. In the “similarity information” item, “1” that is similarity information indicating that records forming a pair are similar to each other or “0” that is similarity information indicating that records forming a pair are not similar to each other is set.

In the teacher data item 133 illustrated in FIG. 18, in information indicating “1” in the “item number” item, information corresponding to the information indicating “1” in the “item number” item in the first master data 131 described with reference to FIG. 16 is set as “first master data”, and information corresponding to the information indicating “1” in the “item number” item in the second master data 132 described with reference to FIG. 17 is set as “second master data”. In the teacher data item 133 illustrated in FIG. 18, in the information indicating “1” in the “item number” item, “1” is set as “similarity information”. A description of other information illustrated in FIG. 18 is omitted.

Returning to FIG. 8, the information managing section 117 sets, in a variable P, a value indicated by information (not illustrated) stored in the information storage region 130 and indicating the number of data items to be generated (in S13). The information indicating the number of generated data items is, for example, defined by the provider in advance and indicates the number of teacher data items 133 to be generated during a period of time when the same value is set in a variable M described later.

Then, the information managing section 117 sets “1” as an initial value in the variable M and a variable P1 (in S14).

The information managing section 117 sets, in a variable N, the number of items included in pairs of records included in each of the teacher data items 133 acquired in the process of S12 (in S15).

For example, the teacher data item 133 described with reference to FIG. 18 includes the five pairs of items including the combination of the “client ID” and “customer ID” items. Thus, in this case, the information managing section 117 sets “5” as an initial value in the variable N.

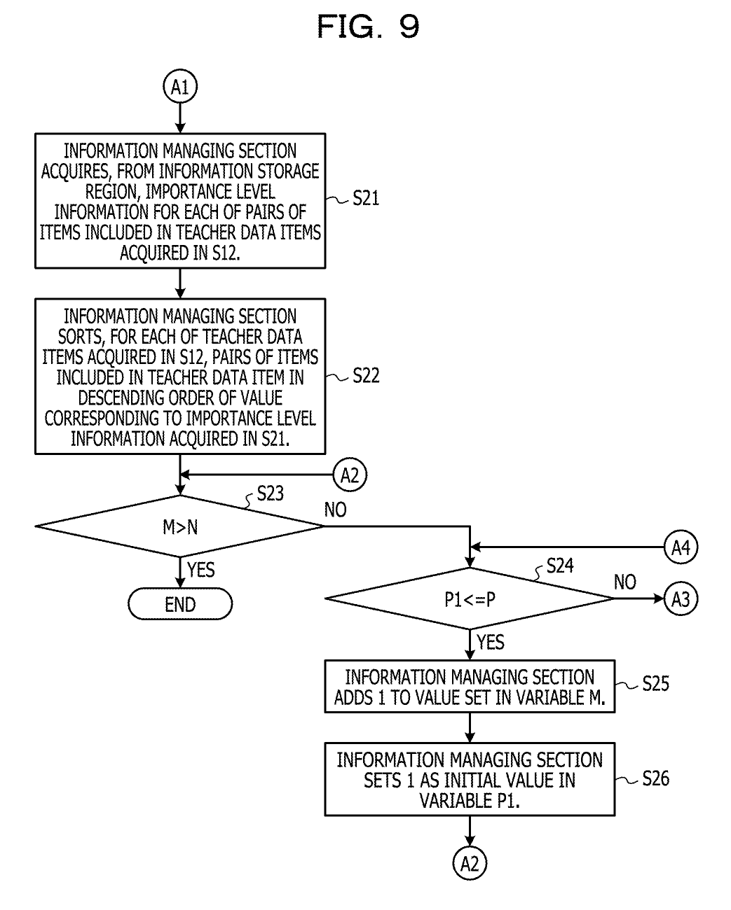

Subsequently, the information managing section 117 acquires the importance level information 134 stored in the information storage region 130 (in S21), as illustrated in FIG. 9.

For example, the information managing section 117 acquires the importance level information 134 for each of the pairs of items included in the teacher data items 133 acquired in the process of S12. The importance level information 134 is, for example, set by the provider in advance and indicates importance levels of the pairs of items included in the teacher data items 133. As the ratio of the number of cells that are included in a pair of items included in the first and second master data 131 and 132 and in which information is not set to the number of cells that are included in the pair of items included in the first and second master data 131 and 132 is lower, an importance level of the pair of items may indicate a higher value. As the ratio of the number of cells that are included in the pair of items included in the first and second master data 131 and 132 and in which information is not set to the number of cells that are included in the pair of items included in the first and second master data 131 and 132 is higher, an importance level of the pair of items may indicate a lower value. The importance levels of the pairs of items may be defined by the provider in advance. A specific example of the importance level information 134 is described below.

<Specific Example of Importance Level Information>

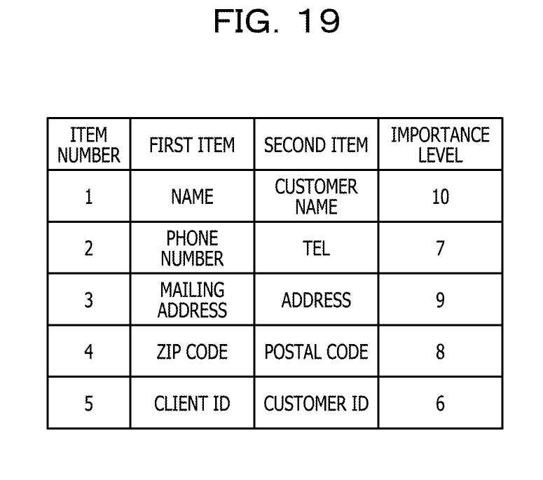

FIG. 19 describes the specific example of the importance level information 134.

The importance level information 134 illustrated in FIG. 19 includes an “item number” item identifying information included in the importance level information 134, a “first item” in which the items included in the first master data 131 are set, and a “second item” in which items that are among the items included in the second master data 132 and are included in pairs of the same items as the items set in the “first item” are set. The importance level information 134 illustrated in FIG. 19 also includes an “importance level” item in which importance levels of pairs of items set in the “first item” and items set in the “second item” are set.

For example, in the importance level information 134 illustrated in FIG. 19, in information indicating “1” in the “item number” item, a “name” is set as a “first item”, a “customer name” is set as a “second item”, and “10” is set as an “importance level”. In the importance level information 134 illustrated in FIG. 19, in information indicating “2” in the “item number” item, a “phone number” is set as a “first item”, “Tel” is set as a “second item”, and “7” is set as an “importance level”. A description of other information illustrated in FIG. 19 is omitted.

Returning to FIG. 9, the information managing section 117 sorts, for each of the teacher data items 133 acquired in the process of S12, pairs of items included in pairs of records of the teacher data item 133 in descending order of value corresponding to the importance level information 134 acquired in the process of S21 (in S22).

Thus, the information processing device 1 may execute the machine learning while prioritizing a pair of items that has a high importance level and is among the pairs of items included in the teacher data items 133.

For example, in the “importance level” item of the importance level information 134 described with reference to FIG. 19, “10”, “9”, “8”, “7”, and “6” are set in this order. In the importance level information 134 described with reference to FIG. 19, information set in the “first item” and included in information indicating “10”, “9”, “8”, “7”, and “6” in the “importance level” item is a “name”, a “mailing address”, a “zip code”, a “phone number”, and a “client ID”.

Thus, as illustrated in FIG. 20, the information managing section 117 sorts information set in the “first master data” item in the teacher data item 133 described with reference to FIG. 18 in the order of information corresponding to “names”, “mailing addresses”, “zip codes”, “phone numbers”, and “client IDs”. Similarly, the information managing section 117 sorts information set in the “second master data” item in the teacher data item 133 described with reference to FIG. 18 in the order of information corresponding to “customer names”, “addresses”, “postal codes”, “Tel”, and “customer IDs”.

Then, the information managing section 117 compares a value set in the variable M with a value set in the variable N (in S23).

When the value set in the variable M is equal to or smaller than the value set in the variable N (No in S23), the information managing section 117 compares a value set in the variable P1 with a value set in the variable P (in S24).

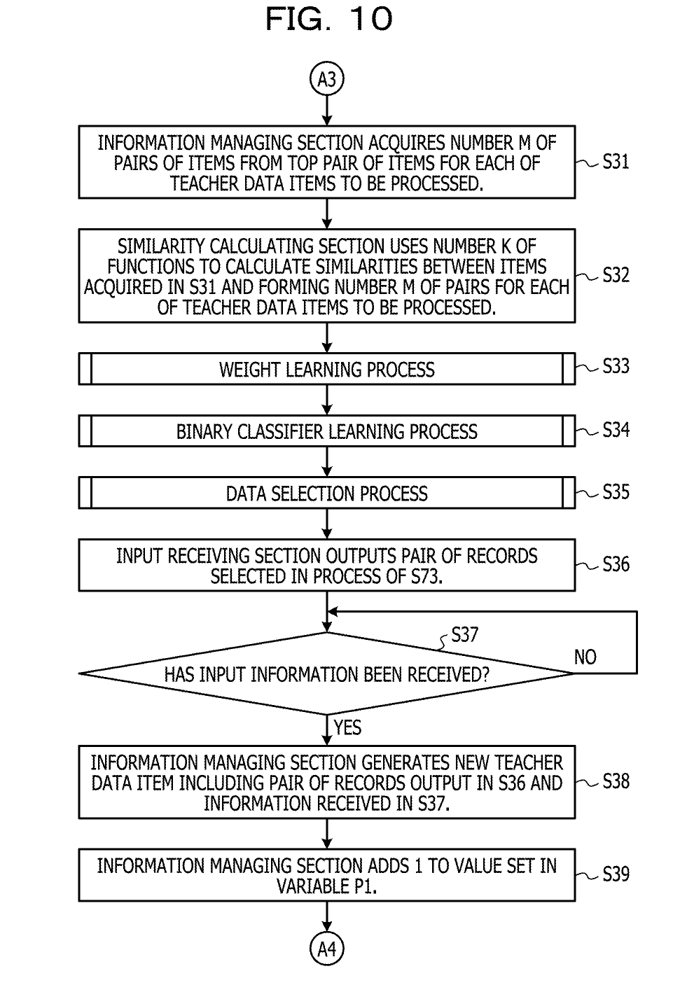

When the value set in the variable P1 is larger than the value set in the variable P (No in S24), the information managing section 117 acquires a number M of pairs of items from the top pair of items for each of the teacher data items 133 to be processed (in S31), as illustrated in FIG. 10.

For example, in a record indicating “1” in the “item number” item in the teacher data item 133 (acquired in the process of S12) described with reference to FIG. 20, “Name: Takeda Trading Corporation, Mailing address: Kanagawa, . . . ” is set as “first master data”. In the record indicating “1” in the “item number” item in the teacher data item 133 described with reference to FIG. 20, “Customer name: Takeda Trading Corporation, Address: Kanagawa prefecture, . . . ” is set as “second master data”. Thus, when the variable M is 1, the information managing section 117 identifies a pair of items “Name: Takeda Trading Corporation” and “Customer name: Takeda Trading Corporation” as a top single pair of items included in the record indicating “1” in the “item number” item.

Similarly, for example, the information managing section 117 identifies a pair of items “Name: Takeda Trading Corporation” and “Customer name: Tanaka Shipbuilding Corporation” as a top single pair of items included in a record indicating “2” in the “item number” item.

Subsequently, the similarity calculating section 111 of the information processing device 1 uses a number K of functions to calculate similarities between the items acquired in the process of S31 and forming the number M of pairs for each of the teacher data items 133 to be processed (in S32). For example, the number K of functions may be an edit distance, a conditional random field, a Euclidean distance, and the like.

Then, the weight learning section 112 of the information processing device 1 executes a weight learning process (in S33). The weight learning process is described below.

<Weight Learning Process>

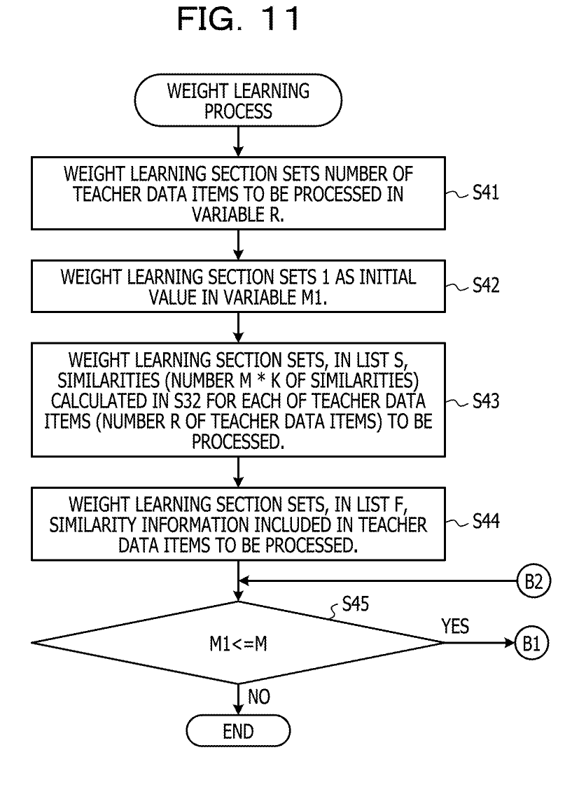

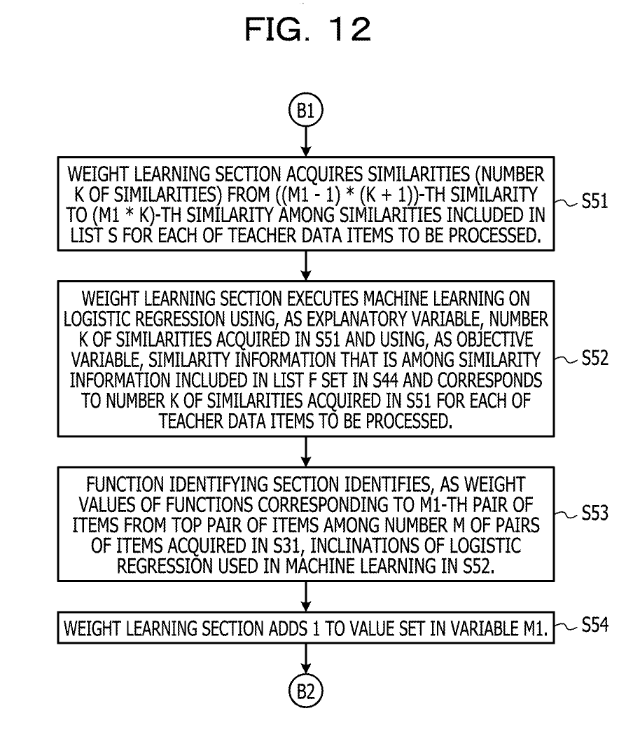

FIGS. 11 and 12 describe the weight learning process.

As illustrated in FIG. 11, the weight learning section 112 sets, in a variable R, the number of teacher data items 133 to be processed (in S41). For example, the weight learning section 112 sets, in the variable R, the number of records of the teacher data items 133 acquired in the process of S12. The weight learning section 112 sets 1 as an initial value in a variable M1 (in S42).

Then, the weight learning section 112 sets the similarities calculated in the process of S32 in a list S for each of the teacher data items 133 to be processed (in S43). For example, the weight learning section 112 sets the similarities calculated in the process of S32 in the list S for each of the teacher data items 133 acquired in the process of S12. A specific example of the list S in the case where the value set in the variable M is 1 is described below.

<First Specific Example of List S>

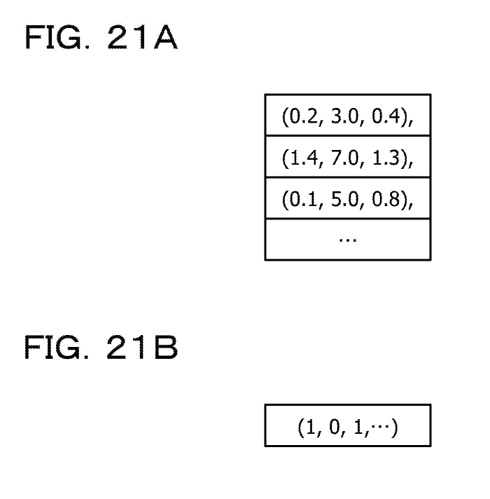

FIG. 21A describes the specific example of the list S in the case where the value set in the variable M is 1.

For example, in the process of S32, when “0.2”, “3.0”, and “0.4” are calculated as similarities corresponding to the record indicating “1” in the “item number” item in the teacher data item 133 described with reference to FIG. 20, “1.4”, “7.0”, and “1.3” are calculated as similarities corresponding to the record indicating “2” in the “item number” item in the teacher data item 133 described with reference to FIG. 20, and “0.1”, “5.0”, and “0.8” are calculated as similarities corresponding to a record indicating “3” in the “item number” item in the teacher data item 133 described with reference to FIG. 20, the weight learning section 112 generates “(0.2, 3.0, 0.4), (1.4, 7.0, 1.3), (0.1, 5.0, 0.8), . . . ” as the list S, as illustrated in FIG. 21A.

Returning to FIG. 11, the weight learning section 112 sets, in a list F, similarity information included in the teacher data items 133 to be processed (in S44). For example, the weight learning section 112 sets, in the list F, similarity information included in records included in the teacher data items 133 acquired in the process of S12. A specific example of the list F is described below.

<First Specific Example of List F>

FIG. 21B describes a specific example of the list F in the case where the value set in the variable M is 1.

For example, in the teacher data item 133 described with reference to FIG. 20, “1”, “0”, and “1” are set in the “similarity information” item of information indicating “1”, “2”, and “3” in the “item number” item. Thus, the weight learning section 112 generates “(1, 0, 1, . . . )” as the list F, as illustrated in FIG. 21B.

Returning to FIG. 11, the weight learning section 112 compares a value set in the variable M1 with a value set in the variable M (in S45).

When the value set in the variable M1 is equal to or smaller than the value set in the variable M (Yes in S45), the weight learning section 112 acquires similarities from an ((M1−1)*(K+1))-th similarity to an (M1*K)-th similarity (or a number K of similarities) from the similarities included in the list S for each of the teacher data items 133 to be processed (in S51), as illustrated in FIG. 12.

For example, when the value set in the variable M1 is 1, the weight learning section 112 acquires the first to third similarities included in the list S for each of records included in the teacher data items 133 acquired in the process of S12.

Then, the weight learning section 112 executes the machine learning on logistic regression using, as an explanatory variable, the number K of similarities acquired in the process of S51 and using, as an objective variable, similarity information that is among the similarity information included in the list F set in the process of S44 and corresponds to the number K of similarities acquired in the process of S51 (in S52).

For example, the weight learning section 112 executes machine learning on the following Equation 2. The similarities (number K of similarities) acquired in the process of S51 are set in X₁, X₂, . . . , X_{K} of Equation 2. For example, the weight learning section 112 repeatedly executes the machine learning using Equation 2 on each of the records included in the teacher data items 133 acquired in the process of S12.

Similarity information=1/(1 exp(−(b₁*X₁+b₂*X₂+ . . . +b_{K}*X_{K}+b₀) (2)

Subsequently, the function identifying section 113 of the information processing device 1 identifies, as weight values of functions corresponding to an M1-th pair of items from the top pair of items among the number M of pairs of items acquired in the process of S31, inclinations of the logistic regression used in the machine learning in the process of S52 (in S53).

For example, the weight learning section 112 identifies, as the weight values of the functions corresponding to the similarities acquired in the process of S51, b₁, b₂, . . . , and b_{K} that are parameters (inclinations) acquired by executing the machine learning using Equation 2.

After that, the weight learning section 112 adds 1 to the value set in the variable M1 (in S54). Then, the weight learning section 112 executes the processes of S45 and later again.

When the value set in the variable M1 is larger than the value set in the variable M (No in S45), the weight learning section 112 terminates the weight learning process.

Returning to FIG. 10, the classifier learning section 114 of the information processing device 1 executes a binary classifier learning process (in S34). The binary classifier learning process is described below.

<Binary Classifier Learning Process>

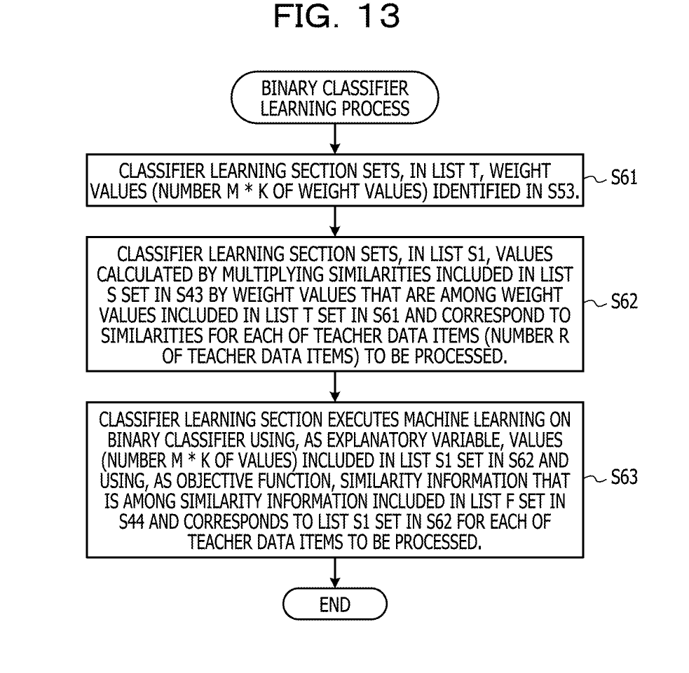

FIG. 13 describes the binary classifier learning process.

The classifier learning section 114 sets, in a list T, the weight values identified in the process of S53 (in S61), as illustrated in FIG. 13. For example, the classifier learning section 114 sets a number M*K of weight values in the list T. A specific example of the list T in the case where the value set in the variable M is 1 is described below.

<First Specific Example of List T>

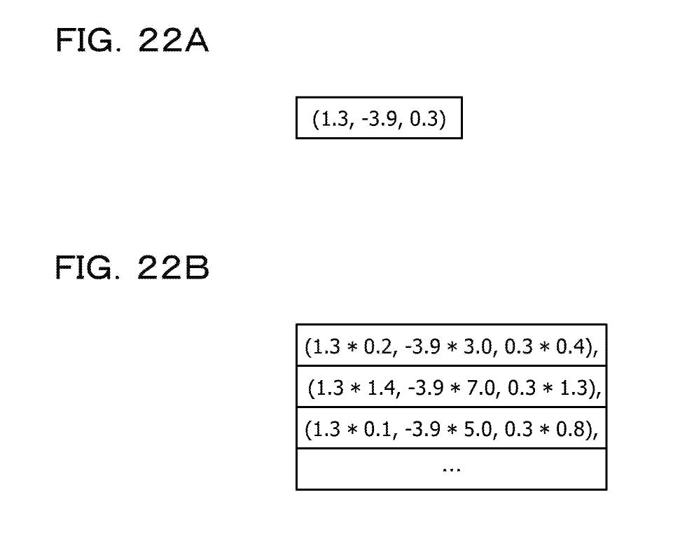

FIG. 22A describes a specific example of the list T in the case where the value set in the variable M is 1.

When “1.3”, “−3.9”, and “0.3” are calculated as weight values corresponding to top pairs of items in the teacher data item 133 described with reference to FIG. 20, the classifier learning section 114 generates “(1.3, −3.9, 0.3)” as the list T, as illustrated in FIG. 22A.

Then, the classifier learning section 114 sets, in a list S1, values calculated by multiplying the similarities included in the list S set in the process of S43 by weight values that correspond to the similarities and are among the weight values included in the list T set in the process of S61 for each of the teacher data items 133 to be processed (in S62). For example, the classifier learning section 114 sets the values in the list S1 for each of the records included in the teacher data items 133 acquired in the process of S12. A specific example of the list S1 in the case where the value set in the variable M is 1 is described below.

<First Specific Example of List S1>

FIG. 22B describes a specific example of the list S1 in the case where the value set in the variable M is 1.

For example, when “(0.2, 3.0, 0.4), (1.4, 7.0, 1.3), (0.1, 5.0, 0.8), . . . ” is generated as the list S, and “(1.3, −3.9, 0.3)” is generated as the list T, the classifier learning section 114 generates “(1.3*0.2, −3.9*3.0, 0.3*0.4), (1.3* 1.4, −3.9*7.0, 0.3*1.3), (1.3*0.1, −3.9*5.0, 0.3*0.8), . . . ” as the list S1, as illustrated in FIG. 22B.

Returning to FIG. 13, the classifier learning section 114 executes the machine learning on the binary classifier using, as an explanatory variable, the values (number M*K of values) included in the list S1 set in the process of S62 and using, as an objective variable, similarity information that corresponds to the list S1 set in the process of S62 and is among the similarity information included in the list F set in the process of S44 (in S63). For example, in the process of S63, the classifier learning section 114 executes the machine learning on logistic regression, decision trees, random forests, or the like.

Returning to FIG. 10, the data selecting section 115 of the information processing device 1 executes a data selection process (in S35). The data selection process is described below.

<Data Selection Process>

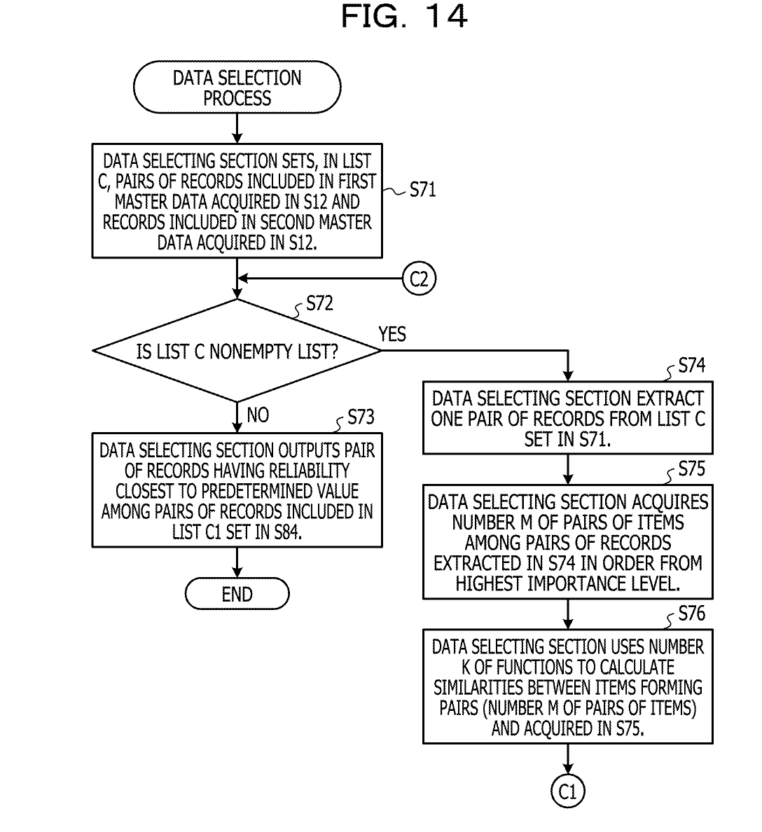

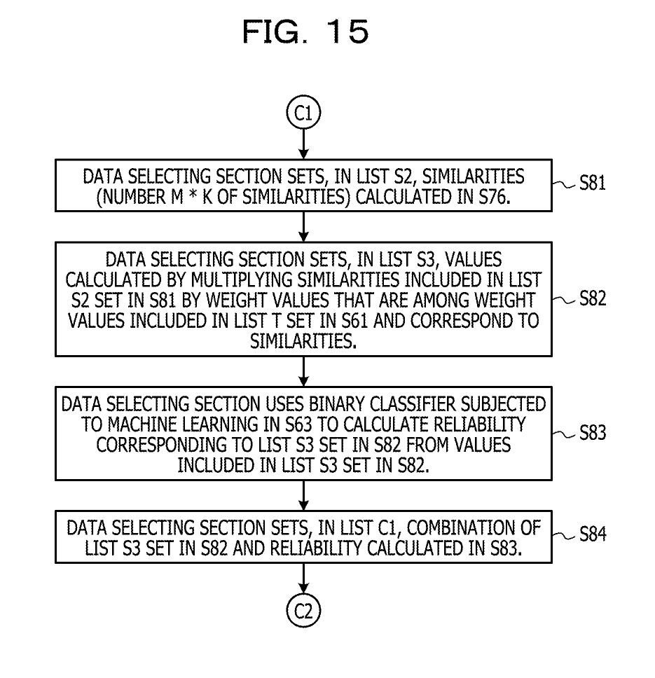

FIGS. 14 and 15 describe the data selection process.

The data selecting section 115 sets, in a list C, the pairs of records included in the first master data 131 acquired in the process of S12 and records included in the second master data 132 acquired in the process of S12 (in S71), as illustrated in FIG. 14. A specific example of the list C is described below.

<First Specific Example of List C>

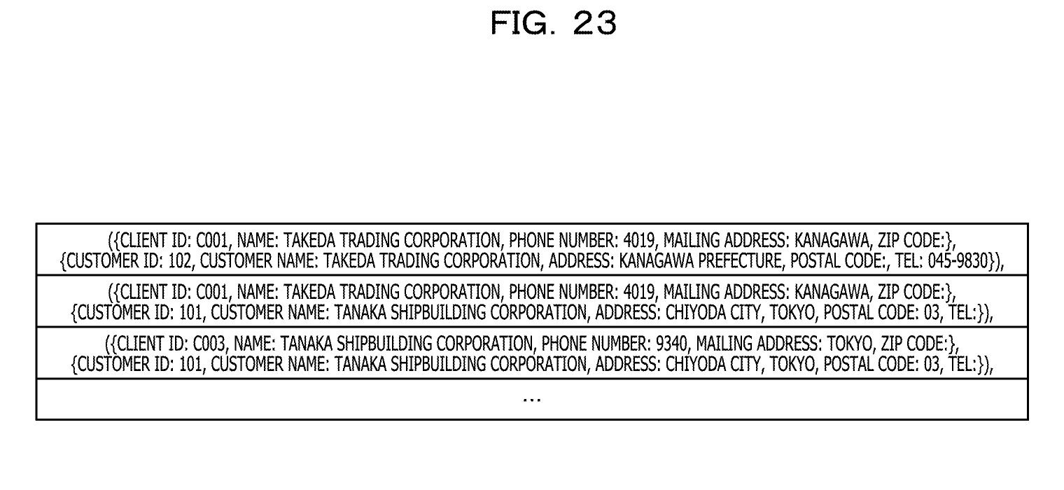

FIG. 23 describes the specific example of the list C.

For example, as illustrated in FIG. 23, the data selecting section 115 sets, in the list C, a pair of records including information corresponding to a record indicating “1” in the “item number” item and included in the first master data 131 described with reference to FIG. 16 and information corresponding to a record indicating “1” in the “item number” and included in the second master data 132 described with reference to FIG. 17. For example, the data selecting section 115 sets, in the list C, a pair of records including information corresponding to a record indicating “2” in the “item number” item and included in the first master data 131 described with reference to FIG. 16 and information corresponding to a record indicating “2” in the “item number” item and included in the second master data 132 described with reference to FIG. 17. A description of other information illustrated in FIG. 23 is omitted.

Returning to FIG. 14, the data selecting section 115 determines whether or not the list C is a nonempty list (in S72).

When the data selecting section 115 determines that the list C is not empty (Yes in S72), the data selecting section 115 extracts one pair of records from the list C set in the process of S71 (in S74). Then, the data selecting section 115 acquires a number M of pairs of items from the pair, extracted in the process of S74, of records in order from the highest importance level (in S75).

For example, when the value set in the variable M is 1 and a pair of records indicating “1” in the “item number” items and included in the list C described with reference to FIG. 23 is acquired in the process of S74, the data selecting section 115 references the importance level information 134 stored in the information storage region 130 and acquires a pair of items having the highest importance level and indicating “Name: Takeda Trading Corporation” and “Customer ID: Takeda Trading Corporation” from the extracted pair of records.

Then, the data selecting section 115 uses the number K of functions to calculate similarities between the items forming the pairs and acquired in the process of S75 (in S76). For example, the data selecting section 115 uses the number K of functions used in the process of S32 to calculate a similarity between the items forming the pair and indicating “Name: Takeda Trading Corporation” and “Customer Name: Takeda Trading Corporation”.

Subsequently, as illustrated in FIG. 15, the data selecting section 115 sets the similarities calculated in the process of S76 in a list S2 (in S81). Then, the data selecting section 115 sets, in a list S3, values calculated by multiplying the similarities included in the list S2 set in the process of S81 by weight values that correspond to the similarities and are among the weight values included in the list T set in the process of S61 (in S82). For example, the data selecting section 115 executes the same processes as those of S62 and the like on the pairs, acquired in the process of S75, of items.

After that, the data selecting section 115 uses the binary classifier subjected to the machine learning in the process of S63 to calculate a reliability corresponding to the list S3 set in the process of S82 from the values included in the list S3 set in the process of S82 (in S83). For example, the data selecting section 115 uses the aforementioned Equation 1 to calculate the reliability.

Then, the data selecting section 115 sets a combination of the list S3 set in the process of S82 and the reliability calculated in the process of S83 in a list C1 (in S84). A specific example of the list C1 in the case where the value set in the variable M is 1 is described below.

<First Specific Example of List C1>

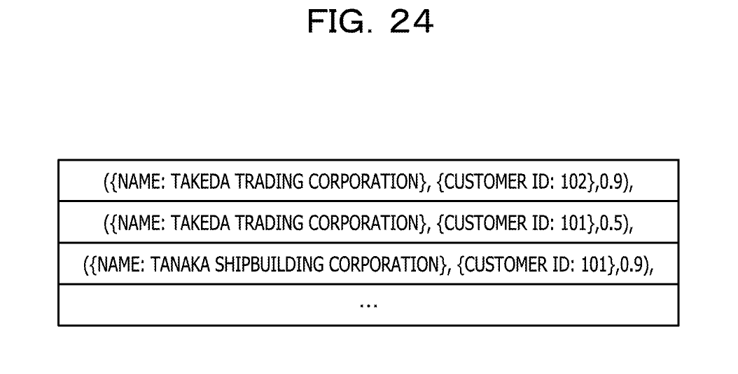

FIG. 24 describes the specific example of the list C1 in the case where the value set in the variable M is 1.

When the pair of items indicating “Name: Takeda Trading Corporation” and “Customer Name: Tanaka Shipbuilding Corporation” is acquired in the process of S75, and “0.9” is calculated as a reliability in the process of S83, the data selecting section 115 generates “({Name: Takeda Trading Corporation}, {Customer Name: Takeda Trading Corporation}, 0.9)” as the list C1, as illustrated in FIG. 24, for example. A description of other information illustrated in FIG. 24 is omitted.

Returning to FIG. 15, after the process of S84, the data selecting section 115 executes the processes of S72 and later.

When the data selecting section 115 determines that the list C is empty (No in S72), the data selecting section 115 outputs a pair of records having a reliability closest to a predetermined value among pairs of records included in the list C1 set in the process of S84 (in S73). For example, the data selecting section 115 outputs a pair of records having a reliability closest to, for example, 0.5 among the pairs of records included in the list C1 set in the process of S84. After that, the data selecting section 115 terminates the data selection process.

Returning to FIG. 10, the input receiving section 116 of the information processing device 1 outputs the pair of records selected in the process of S73 (in S36). For example, the input receiving section 116 outputs, to an output device (not illustrated) of the operation terminal 3, the pair of records selected in the process of S73.

After that, the input receiving section 116 stands by until information indicating whether or not the records forming the pair and selected in the process of S73 are similar to each other is input by the provider (No in S37).

When the information indicating whether or not the records forming the pair and selected in the process of S73 are similar to each other is input by the provider (Yes in S37), the information managing section 117 generates a new teacher data item 133 including the pair of records output in the process of S36 and the information received in the process of S37 (in S38).

In this case, the information managing section 117 adds 1 to the value set in the variable P1 (in S39).

After that, the information managing section 117 executes the processes of S24 and later again. When the value set in the variable P1 is 2 or more, the information processing device 1 executes the processes of S24 and later on only the new teacher data item 133 generated in the process of S38 executed immediately before the process of S39.

When the value set in the variable P1 is equal to or smaller than the value set in the variable P (Yes in S24), the information managing section 117 adds 1 to the value set in the variable M (in S25).

For example, the information processing device 1 uses only similarities between items forming top pairs and included in teacher data items 133 stored in the information storage region 130 to generate new teacher data items 133, where the number of generated new teacher data items 133 corresponds to the value set in the variable P. After that, for example, the information processing device 1 uses not only the top pairs of items included in the teacher data items 133 stored in the information storage region 130 but also the similarities between the items forming the top pairs and included in teacher data items 133 to generate new teacher data items 133, where the number of generated new teacher data items 133 corresponds to the value set in the variable P.

Thus, the information processing device 1 may increase the dimension of the high-dimensional space described with reference to FIGS. 2 to 4 in a stepwise manner. Thus, the information processing device 1 may use similarities between items forming pairs and having high importance levels on a priority basis and efficiently generate new teacher data items 133 that may enable the accuracy of the name identification process to be improved. Thus, the information processing device 1 may suppress the number of teacher data items 133 to be subjected to the machine learning in order to improve the accuracy of the name identification process to a desirable level.

Subsequently, the information managing section 117 sets 1 as an initial value in the variable P1 (in S26). After that, the information managing section 117 executes the processes of S23 and later again.

When the value set in the variable M is larger than the value set in the variable N (Yes in S23), the information processing device 1 terminates the learning process.

The information processing device 1 may terminate the learning process before the value set in the variable M exceeds the value set in the variable N. For example, the information processing device 1 may terminate the learning process without using a similarity between items forming a pair and having a low importance level.

<Specific Examples in Case Where Value Set in Variable M is 4>

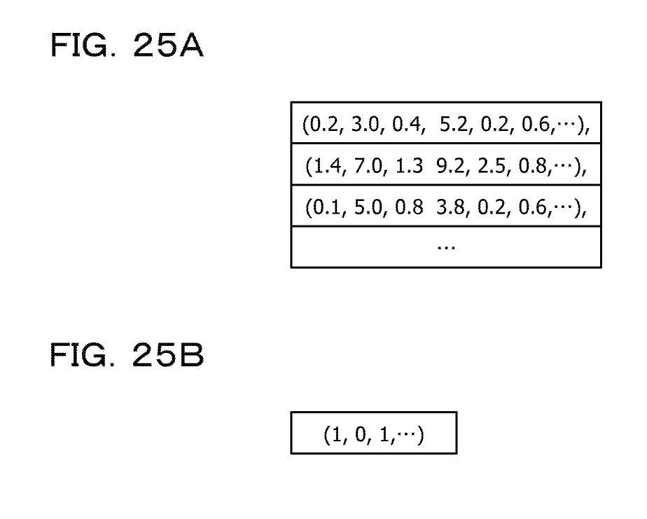

Next, specific examples in which the value set in the variable M is 4 are described. FIGS. 25A to 28 describe the specific examples in the case where the value set in the variable M is 4.

<Second Specific Example of List S>

First, a specific example of the list S in the case where the value set in the variable M is 4 is described. A specific example of the list S set in the process of S43 after the process is completed in a state in which the value set in the variable M is 3 after the process executed in a state in which the value set in the variable M is 1 is described below. FIG. 25A describes a specific example of the list S set in the case where the value set in the variable M is 4.

For example, in the process of S32, when “0.2”, “3.0”, “0.4”, “5.2”, “0.2”, “0.6”, and the like are calculated as similarities corresponding to records indicating “1” in the “item number” items included in the teacher data item 133 described with reference to FIG. 20, “1.4”, “7.0”, “1.3”, “9.2”, “2.5”, “0.8”, and the like are calculated as similarities corresponding to records indicating “2” in the “item number” items included in the teacher data item 133 described with reference to FIG. 20, “0.1”, “5.0”, “0.8”, “3.8”, “0.2”, “0.6”, and the like are calculated as similarities corresponding to records indicating “3” in the “item number” items included in the teacher data item 133 described with reference to FIG. 20, the weight learning section 112 generates “(0.2, 3.0, 0.4, 5.2, 0.2, 0.6, . . . ), (1.4, 7.0, 1. 3, 9.2, 2.5, 0.8, . . . ), (0.1, 5.0, 0.8, 3.8, 0.2, 0.6, . . . ), . . . ” as the list S, as illustrated in FIG. 25A.

When the value set in the variable M is 4, the weight learning section 112 calculates 12 similarities for each of the teacher data items 133 to be processed in the process of S32, for example. Thus, in the process of S43, the weight learning section 112 generates the list S including combinations of the 12 similarities for the number of teacher data items 133 to be processed.

<Second Specific Example of List F>

Next, a specific example of the list F in the case where the value set in the variable M is 4 is described. For example, a specific example of the list F set in the process of S44 after the process is completed in a state in which the value set in the variable M is 3 after the process executed in a state in which the value set in the variable M is 1 is described below. FIG. 25B describes the specific example of the list F in the case where the value set in the variable M is 4.

For example, “1”, “0”, and “1” are set in the “similarity information” item in information indicating “1” to “3” in the “item number” item in the teacher data item 133 described with reference to FIG. 20. Thus, the weight learning section 112 generates “(1, 0, 1, . . . )” as the list F, as illustrated in FIG. 25B.

<Second Specific Example of List T>

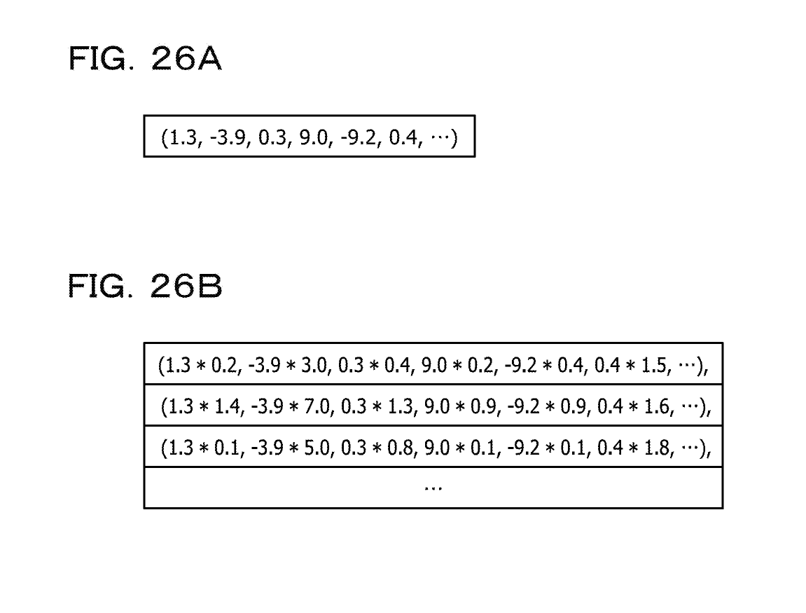

Next, a specific example of the list T in the case where the value set in the variable M is 4 is described. For example, a specific example of the list T set in the process of S61 after the process is completed in a state in which the value set in the variable M is 3 after the process executed in a state in which the value set in the variable M is 1 is described. FIG. 26A describes the specific example of the list T set in the case where the value set in the variable M is 4.

For example, when “1.3”, “−3.9”, “0.3”, “9.0”, “−9.2”, “0.4”, and the like (12 weight values) are calculated as weight values corresponding to pairs of items included in records indicating “1” in the “item number” item and included in the teacher data item 133 described with reference to FIG. 20, the classifier learning section 114 generates “(1.3, −3.9, 0.3, 9.0, −9.2, 0.4, . . . )” as the list T, as illustrated in FIG. 26A.

<Second Specific Example of List S1>

Next, a specific example of the list S1 in the case where the value set in the variable M is 4 is described. For example, a specific example of the list S1 set in the process of S62 after the process is completed in a state in which the value set in the variable M is 3 after the process executed in a state in which the value set in the variable M is 1 is described below. FIG. 26B describes the specific example of the list S1 set in the case where the value set in the variable M is 4.

For example, when the list S described with reference to FIG. 25A is generated in the process of S43, and the list T described with reference to FIG. 26A is generated in the process of S61, the classifier learning section 114 generates “(1.3*0.2, −3.9*3.0, 0.3*0.4, 9.0*0.2, −9.2*0.4, 0.4*1.5, . . . ), (1.3*1.4, −3.9*7.0, 0.3*1.3, 9.0*0.9, −9.2*0.9, 0.4*1.6, . . . ), (1.3*0.1, −3.9*5.0, 0.3*0.8, 9.0*0.1, −9.2*0.1, 0.4*1.8, . . . ), . . . ” as the list S1, as illustrated in FIG. 26B.

<Second Specific Example of List C1>

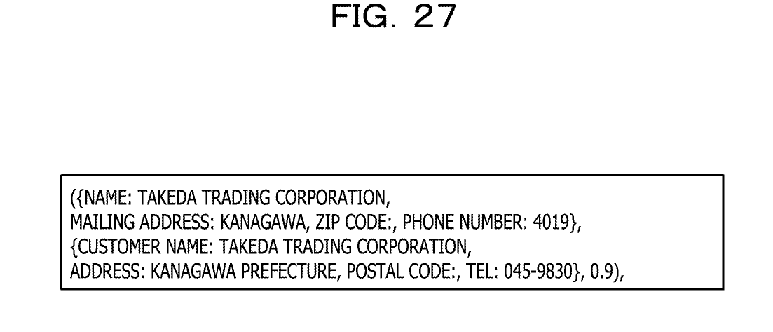

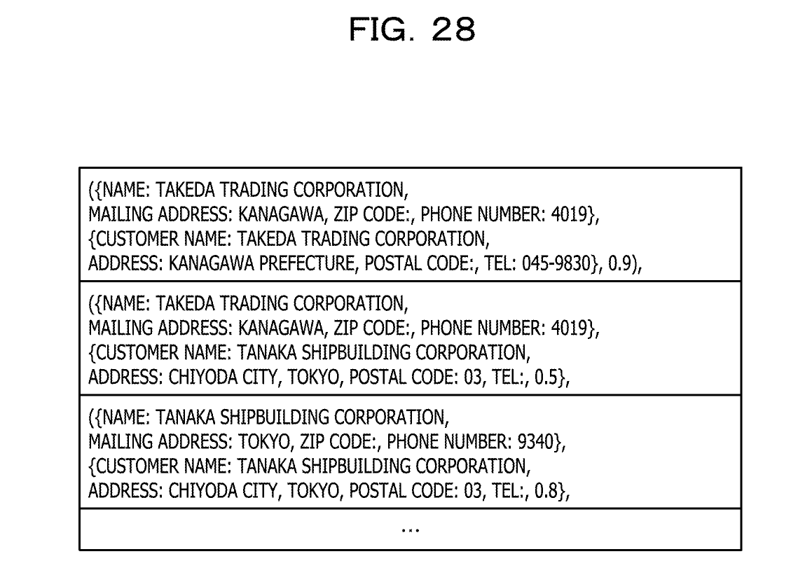

Next, a specific example of the list C1 in the case where the value set in the variable M is 4 is described. A specific example of the list C1 set in the process of S84 after the process is completed in a state in which the value set in the variable M is 3 after the process executed in a state in which the value set in the variable M is 1. FIGS. 27 and 28 describe the specific example of the list C set in the state in which the value set in the variable M is 4.

For example, when a pair of items indicating “Name: Takeda Trading Corporation” and “Customer Name: Takeda Trading Corporation”, a pair of items indicating “Mailing Address: Kanagawa” and “Address: Kanagawa prefecture”, a pair of items indicating “Zip code:” and “Postal code:”, a pair of items indicating “Phone number: 4019” and “Tel: 045-9830” are acquired in the process of S75, and “0.9” is calculated as a reliability in the process of S83, the data selecting section 115 generates “({Name: Takeda Trading Corporation, Mailing Address: Kanagawa, Zip code:, Phone number: 4019}, {Customer Name: Takeda Trading Corporation, Address: Kanagawa prefecture, Postal code:, Tel: 045-9830}, 0.9)” as the list C1, as illustrated in FIG. 27.

When the list C is empty, the data selecting section 115 references the list C1 illustrated in FIG. 28 and outputs a pair of records (for example, a second top pair of records) having a value set as a reliability and closest to “0.5” (No in S72 and in S73). After that, the information managing section 117 generates a new teacher data item 133 including the output pair of records (in S38).

The information processing device 1 according to the embodiment executes the machine learning on weight values corresponding to multiple functions to be used to calculate similarities between items forming pairs and included in a pair of records of a teacher data item 133 based on the teacher data item 133 stored in the storage device 2c. Then, the information processing device 1 identifies, for each of the pairs of items, an evaluation function to be used to calculate a similarity between the items forming the pair, based on the multiple functions and the weight values corresponding to the multiple functions.

For example, the information processing device 1 according to the embodiment acquires the weight values for the pairs of items and for the multiple functions by executing the machine learning on a function (for example, logistic regression) using, as an objective variable, similarity information included in the teacher data item 133 and using, an explanatory variable, similarities between the items forming the pairs and included in the pair of records. Then, the information processing device 1 calculates functions using the acquired weight values for the pairs of items as evaluation functions for the pairs of items.

Thus, the information processing device 1 may acquire the weight values of the functions to be used to calculate the similarities between the items forming the pairs for each of the pairs of items. Thus, the information processing device 1 may replace the weight values of the functions with each other for each of the pairs of items, thereby calculating similarities using the same functions (multiple functions) for all the pairs of items. Thus, the provider may not determine a function for each of the pairs of items and may reduce a workload caused by the execution of the name identification process.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for machine learning performed by a computer, the method comprising:
executing a first process that includes executing machine learning on weight values corresponding to multiple functions to be used to calculate similarities between items forming pairs and included in first and second data included in a teacher data item for each of the pairs of items based on the teacher data item stored in a memory; and
executing a second process that includes identifying evaluation functions to be used to calculate the similarities between the items forming the pairs based on the multiple functions and the weight values corresponding to the multiple functions.

2. The method according to claim 1,
wherein the pairs of items are pairs of items included in the first data and items included in the second data.

3. The method according to claim 1,
wherein the second process is configured to identify, as an evaluation function, a function of calculating the sum of products of values calculated by the multiple functions and the weight values corresponding to the multiple functions.

4. The method according to claim 1,
wherein the teacher data item includes similarity information indicating whether or not the first data is similar to the second data,
wherein the first process is configured to
use the multiple functions to calculate the similarities for the pairs of items and for the multiple functions, and
use a first function, which uses the similarity information as an objective variable and uses the similarities for the pairs of items and for the multiple functions as an explanatory variable, to execute the machine learning on the weight values for the pairs of items and for the multiple functions.

5. The method according to claim 1,
wherein the teacher data item includes similarity information indicating whether or not the first data is similar to the second data,
wherein the method further comprises:
executing a third process that includes using the evaluation functions to calculate the similarities for the pairs of items;
executing a fourth process that includes executing machine learning on a parameter to be used to calculate a reliability of a determination result indicating whether or not certain data and other data are similar to each other from the calculated similarities and the similarity information;
executing a fifth process that includes using the parameter subjected to the machine learning to calculate a reliability corresponding to third and fourth data stored in the memory;
executing a sixth process that includes receiving information input by a user and indicating a determination result indicating whether or not the third data is similar to the fourth data when the calculated reliability corresponding to the third and fourth data satisfies a predetermined requirement; and
executing a seventh process that includes storing data including the received input information, the third data, and the fourth data as a new teacher data item in the memory.

6. The method according to claim 5, further comprising:
executing an eighth process that includes identifying an evaluation function corresponding to the new teacher data item.

7. The method according to claim 5,
wherein the first process is configured to
reference the memory storing information indicating importance levels of the pairs of items and identify a predetermined number of pairs of items in order from the highest importance level from the pairs of items of the first and second data, and
execute the machine learning on the weight values corresponding to the multiple functions for each of the identified predetermined number of pairs of items,
wherein the second process is configured to
identify an evaluation function for each of the identified predetermined number of pairs of items in the identifying the evaluation functions, and
wherein the third process is configured to
calculate similarities between the items forming the identified predetermined number of pairs.

8. The method according to claim 7, further comprising:
executing a ninth process that includes, after the execution of the seventh process,
identifying the predetermined number or more of pairs of items among the pairs of items included in the first and second data in order from the highest importance level,
executing, based on the teacher data item, the machine learning on the weight values corresponding to the multiple functions for each of pairs of items that are among the identified predetermined number or more of pairs of items and are not subjected to the machine learning to be executed on the weight values,
identifying an evaluation function for each of the pairs of items that are among the identified predetermined number or more of pairs of items and are not subjected to the machine learning to be executed on the weight values,
calculating a similarity for each of the pairs of items that are among the identified predetermined number or more of pairs of items and are not subjected to the machine learning to be executed on the weight values,
executing the machine learning on the parameter using the similarity information and similarities between the items forming the identified predetermined number or more of pairs, and
calculating the reliability corresponding to the third and fourth data, receiving the input information, and storing the new teacher data item again.

9. The method according to claim 7,
wherein as the ratio of the number of cells that are included in a pair of items in the teacher data item and in which information is not set to the number of cells included in the pair of items is higher, an importance level of the pair of items is lower.

10. A non-transitory computer-readable storage medium for storing a program which causes a processor to perform processing for machine learning, the processing comprising:
executing a first process that includes executing machine learning on weight values corresponding to multiple functions to be used to calculate similarities between items forming pairs and included in first and second data included in a teacher data item for each of the pairs of items based on the teacher data item stored in a memory; and
executing a second process that includes identifying evaluation functions to be used to calculate the similarities between the items forming the pairs based on the multiple functions and the weight values corresponding to the multiple functions.

11. The non-transitory computer-readable storage medium according to claim 10,
wherein the pairs of items are pairs of items included in the first data and items included in the second data.

12. The non-transitory computer-readable storage medium according to claim 10,
wherein the second process is configured to identify, as an evaluation function, a function of calculating the sum of products of values calculated by the multiple functions and the weight values corresponding to the multiple functions.

13. The non-transitory computer-readable storage medium according to claim 10,
wherein the teacher data item includes similarity information indicating whether or not the first data is similar to the second data,
wherein the first process is configured to
use the multiple functions to calculate the similarities for the pairs of items and for the multiple functions, and
use a first function, which uses the similarity information as an objective variable and uses the similarities for the pairs of items and for the multiple functions as an explanatory variable, to execute the machine learning on the weight values for the pairs of items and for the multiple functions.

14. The non-transitory computer-readable storage medium according to claim 10,
wherein the teacher data item includes similarity information indicating whether or not the first data is similar to the second data,
wherein the method further comprises:
executing a third process that includes using the evaluation functions to calculate the similarities for the pairs of items;
executing a fourth process that includes executing machine learning on a parameter to be used to calculate a reliability of a determination result indicating whether or not certain data and other data are similar to each other from the calculated similarities and the similarity information;
executing a fifth process that includes using the parameter subjected to the machine learning to calculate a reliability corresponding to third and fourth data stored in the memory;
executing a sixth process that includes receiving information input by a user and indicating a determination result indicating whether or not the third data is similar to the fourth data when the calculated reliability corresponding to the third and fourth data satisfies a predetermined requirement; and
executing a seventh process that includes storing data including the received input information, the third data, and the fourth data as a new teacher data item in the memory.

15. The non-transitory computer-readable storage medium according to claim 14, wherein the processing further comprises:
executing an eighth process that includes identifying an evaluation function corresponding to the new teacher data item.

16. The non-transitory computer-readable storage medium according to claim 14,
wherein the first process is configured to
reference the memory storing information indicating importance levels of the pairs of items and identify a predetermined number of pairs of items in order from the highest importance level from the pairs of items of the first and second data, and
execute the machine learning on the weight values corresponding to the multiple functions for each of the identified predetermined number of pairs of items,
wherein the second process is configured to
identify an evaluation function for each of the identified predetermined number of pairs of items in the identifying the evaluation functions, and
wherein the third process is configured to
calculate similarities between the items forming the identified predetermined number of pairs.

17. The non-transitory computer-readable storage medium according to claim 16, wherein the processing further comprises:
executing a ninth process that includes, after the execution of the seventh process,
identifying the predetermined number or more of pairs of items among the pairs of items included in the first and second data in order from the highest importance level,
executing, based on the teacher data item, the machine learning on the weight values corresponding to the multiple functions for each of pairs of items that are among the identified predetermined number or more of pairs of items and are not subjected to the machine learning to be executed on the weight values,
identifying an evaluation function for each of the pairs of items that are among the identified predetermined number or more of pairs of items and are not subjected to the machine learning to be executed on the weight values,
calculating a similarity for each of the pairs of items that are among the identified predetermined number or more of pairs of items and are not subjected to the machine learning to be executed on the weight values,
executing the machine learning on the parameter using the similarity information and similarities between the items forming the identified predetermined number or more of pairs, and
calculating the reliability corresponding to the third and fourth data, receiving the input information, and storing the new teacher data item again.

18. The non-transitory computer-readable storage medium according to claim 16,
wherein as the ratio of the number of cells that are included in a pair of items in the teacher data item and in which information is not set to the number of cells included in the pair of items is higher, an importance level of the pair of items is lower.

19. An apparatus for machine learning, the apparatus comprising:
a memory; and
a processor coupled to the memory, the processor being configured to
execute a first process that includes executing machine learning on weight values corresponding to multiple functions to be used to calculate similarities between items forming pairs and included in first and second data included in a teacher data item for each of the pairs of items based on the teacher data item stored in a memory; and
execute a second process that includes identifying evaluation functions to be used to calculate the similarities between the items forming the pairs based on the multiple functions and the weight values corresponding to the multiple functions.
